(19) United States
(12) Patent Application Publication
(10) Pub. No.: US 2006/0158756 A1
(43) Pub. Date: Jul. 20, 2006

(54) Programmable laser illuminated sign apparatus

(75) Inventor: Alexander Montagu Hay, Bellevue, WA (US)

Correspondence Address: Anthony Claiborne, 849 136th Ave. N. E., Bellevue, WA, 98005, US

(73) Assignee: Greenco L.L.C., DBA LFI International, Bellevue, WA (US)

(21) Appl. No.: 11/385,107

(22) Filed: Mar. 20, 2006

Related U.S. Application Data
(63) Continuation of application No. PCT/US04/11755, filed on Apr. 16, 2004.
(60) Provisional application No. 60/505,242, filed on Sep. 23, 2003.

(51) Int. Cl. G02B 5/10

(52) U.S. Cl. 359/858

(57) ABSTRACT

A self-contained sign, illuminated by laser or other source of substantially parallel beams, presenting intensely lighted and vividly colored displays, is programmable to display one or more user designed images through controlled deflection of projected beams. The sign comprises a backlit illuminated apparatus of low depth to display dimension ratio, astigmatically correcting distortion of the projected dot resulting from oblique projection angles, such correction occurring in the projected beam's light path prior to controlled beam deflection. Embodiments further normalize obliquely incident light by employing a transmissive refractive right angle structure. Distortion of a projected image is minimized by appropriate pre- or post-processing of display data. Embodiments enable animation of images and are adaptable to networked control.

### CROSS-REFERENCE TO RELATED APPLICATION

This application is a continuation of PCT application number PCT/US04/11755, filed Apr. 16, 2004, which claims priority from U.S. provisional application No. 60/505,242, filed Sep. 23, 2003, titled PROGRAMMABLE LASER ILLUMINATED SIGN APPARATUS.

### BACKGROUND OF THE INVENTION

1. Technical Field

This invention relates to the field of card, picture or sign exhibiting, specifically to a self-contained illuminated sign apparatus employing an internal laser light source programmably to render user defined images, and to systems and methods for the programming and control thereof.

2. Description of the Related Art

Neon lighting is a very well known form of signage. Such signs have long been valued in advertising and display, both because of the vivid colors and high light intensity produced by their glowing ionized gases, and because the neon sign's glass tubes may be bent to shape, thereby permitting, in the hands of a skilled artisan, the production of a customized neon sign for almost any particular image. Furthermore, by cleverly arranging neon tubes that are differentially activated over time, it is possible to fabricate neon signs that produce desirable animated effects, see for example U.S. Pat. No. 1,812,340 to Hotchner.

Despite its advantages, the use of neon lighted signage generally has declined over the last half century, principally because of certain disadvantages inherent in the technology. The production of a neon sign of even modestly elaborate design requires the hand labor of a glass bender to produce the shaped tubes necessary to form the design. Such handicraft requires skilled labor and realizes little economy in increasing scale of production. Further, neon signs, crafted of glass tubes, are both highly susceptible to breakage and expensive to repair. Yet further, a neon sign, once crafted, is difficult to modify in order to change the displayed design: new designs generally require a new sign.

New lighting techniques have been employed to simulate neon lighting in signage without some of neon's disadvantages. For example, U.S. Pat. No. 4,373,283, issued to Swartz, describes an advertising display that simulates a neon sign. In Swartz, a transparent panel of plastic has a display printed thereon. Portions of the display panel that are to simulate neon tubes comprise colored translucent material, while the remainder of the display panel is opaque and black. Backlighting of the display panel with fluorescent lighting results in light transmitted through the colored translucent portions of the panel thereby simulating glowing neon tubes. Such simulated neon displays are an advantageous improvement over true neon in that they may be relatively easily mass-produced, they are considerably less prone to breakage and they are much more easily and economically maintained. Such signs can employ alternately lighted elements in the manner of neon displays to provide animated effects.

While numerous improvements have been made in simulated neon display technology (for example, U.S. Pat. No. 6,205,691 to Urda et al.), in general simulated neon displays do not approach true neon lighting in either vividness of color or in light intensity. Furthermore, as with neon signs, modification of simulated neon displays is difficult, a new design generally requiring an entirely new sign.

The desirability of changeable signs has long been recognized. Changeable signage is by its nature more adaptable to changing display requirements than is signage such as neon and simulated neon, which may be modified, if at all, with great difficulty. Further, changeable signage permits business models that are inapplicable to fixed signage. For example, the billboard advertising business, classically employing a replaceable printed or painted image on a billboard surface to provide signage to others for limited periods of time, is predicated upon changeable signage. For many years, inventive activity has been conducted to develop signage that may be economically and quickly changed, see for example U.S. Pat. No. 634,405 to Douglass.

Technology that presents a plurality of images over a relatively short time without changing signage affords yet further business models. Well known to those in the art are signs with aligned rotatable triangular parallelepiped elements, such as taught in U.S. Pat. No. 3,199,239 to Reed. Each face of each such element contains a painted or printed portion of one of three images. As the elements are rotated about their axes in unison, the elements are aligned so that the sign presents each of the three images in turn. Employing such technologies, a billboard advertising business may utilize a single sign to provide signage space to a plurality of different advertisers for the same period of time.

Animation has long been recognized as an improvement in the ability of a display to attract and hold a viewer's attention. In addition to the animation technique of sequentially lighting alternate elements as used in neon and related signage technology, there are a wide range of technologies employed to provide animation for displays. Very simple mechanical devices have long been used to provide animation in signage, see for example U.S. Pat. No. 666,188 to DuBois. Electromechanical devices with illumination have further extended signage animation technology. In U.S. Pat. No. 4,173,085 to Cortez, for example, colored translucent back-illuminated discs rotate behind a transparent panel on which is painted a picture with appropriate unpainted transparent areas, thereby creating the animation of shimmering objects such as waters or stars in such transparent areas. Lenticular technology, well known to those in the art, is also used to provide animated effects for displays, as in U.S. Pat. No. 4,766,684 to Wa Lo. As new display materials are developed, many are adapted for animation of displays, for example electro-optical voltage controlled cells in U.S. Pat. No. 5,122,890 to Makow and electronic paper in U.S. Pat. No. 6,588,131 to O'Connell.

Video display technologies are widely used in advertising. CRT or flat screen technology permits advertising displays of relatively modest dimensions for indoor or sheltered outdoor use. For example, U.S. design Pat. 373,145 to Middlebrook describes the ornamental design for a video advertising display module adapted for mounting on a ceiling and comprising a plurality of video displays. U.S. Pat. No. 6,206,142 to Meacham describes a video based elevator advertising system. U.S. Pat. No. 6,567,842 to DeLeo et al. describes ATM video advertising. Projection television sets can be used for indoor advertising of somewhat larger dimensions, as described in U.S. Pat. No. 4,739,396 to Hyatt.

Although inadequately luminous for daylight use, video projector technology permits outdoor advertising of billboard dimensions at night, as described for example in U.S. Pat. No. 5,570,138 to Baron. Projector technology in general, however, is less advantageous than other display technologies, in requiring location of the projector distant from the display surface and in requiring an unobstructed light path between the projector and the projection surface.

Video display technologies are well adapted to network control of display units, permitting one-to-many broadcast of advertising to a plurality of distributed displays as well as one-to-one and one-to-few narrowcasting, entailing the delivery of targeted advertising to specific video display units or groups of units. For example, U.S. Pat. No. 4,264,924 to Freeman describes a cable television system enabling the delivery of individually tailored messages to individual cable television subscribers.

While video display technology permits the aforesaid advantages of changeable displays, animation, presentation of an unlimited plurality of images, and adaptability to network control, video displays are significantly inferior to neon displays in vividness of color and light intensity, so much so that self-contained video displays are relatively ineffective for signage purposes, while projected video displays are merely moderately effective only in low ambient light environments.

It has long been known in the art that projected laser beams can create displays of pronounced light intensity and vividness of color. For example, U.S. Pat. No. 5,646,361 to Morrow shows a display device capable of rendering a “visual spectacle” in response to music. Unlike displays required for signage, however, Morrow's device and related devices by others are incapable of rendering specific images and are intended, instead, to display patterns of light and color that are merely amusing but without content.

Image rendering by devices employing projected laser beams is accomplished in general by apparatus which optically deflects and modulates laser beams under programmatic control. For example, U.S. Pat. No. 3,737,573 to Kessler describes the use of Bragg diffraction and acoustic-optic coupling technology to render images generally. U.S. Pat. No. 4,006,970 to Slater describes an early laser projection system capable of rendering various vector graphically rendered figures, including Lissajous figures, stars, triangles, helices, cycloids, etc. Improvements to this earlier technology, including advantageous employment of galvano-mirrors (see for example U.S. Pat. No. 5,044,710 to Iwai et al.), amplitude modulation (see for example U.S. Pat. No. 5,130,838 to Tanaka), acoustic-optic tunable filters (see for example U.S. Pat. No. 5,686,020), and dichroic filter groups (see for example U.S. Pat. No. 5,715,021 to Gibeau et al.), enable modern laser projection apparatus using vector graphics to render virtually limitless forms and colors of neon-like wire-frame and other images, including animation (see for example U.S. Pat. No. 4,978,216 to Liljegren et al.).

Laser projection technology has also been adapted for raster scanned video technology (see for example U.S. Pat. No. 4,297,723 to Whitby and U.S. Pat. No. 5,440,352 to Deter et al.). Such systems are capable of rendering images of a video signal according to a standard format, such as NTSC. Because of the potential commercial potential of an economical laser projection television technology, considerable inventive effort and activity has been directed to this area of art.

However, because the image is rendered by raster scan over an entire screen surface, rather than rendered point-wise as by vector graphics, extremely powerful and expensive laser light sources are necessary to render such video images with an acceptable amount of light intensity on a larger screen. Use of such high intensity laser light in a projector presents health concerns regarding persons who come between the light source and the projection surface (see for example U.S. Pat. No. 5,117,221 to Mishica). The employment of such high intensity laser light permitting human access to high levels of radiation during operation is closely regulated in the United States by the Food and Drug Administration's Center for Devices and Radiological Health.

Even when the intensity of the laser radiation is lower, as in vector graphic laser projection systems, however, the use of laser projection technology suffers from the same shortcomings set forth above for video projection technology: they are not self-contained and are not adaptable to many environments where signage is desirable.

Heretofore, attempts at creating a self-contained laser display comprising a projected backlighted display have been limited by the applicability of prior art laser projection technology to the geometric limitations of a preferred self-contained display. Ideally, a self-contained laser display device suitable for signage should have a relatively large width and breadth of display and a relatively shallow depth. However, laser projection systems are principally based upon the deflection of a laser beam by a pair of galvanometric scanners that provide deflection of the laser beam in the x and y axes. The resulting projection area which galvanometric scanners are able to cover is dictated by the deflection angle capability of the scanners, which in the present art is limited to about 60 degrees or less. This restricts the largest image that may be reproduced on a projection surface to a size about equal on a side to the distance from the projector to the projection surface (see for example U.S. Pat. No. 5,130,838 to Tanaka and U.S. Pat. No. 6,392,821 to Benner, Jr.).

Further limiting attempts at creating a self-contained laser projection apparatus of acceptably shallow depth for signage is the astigmatic effect on the shape of the point rendered by the projected beam as the angle of incidence of the beam to the back-lit screen becomes more obtuse. Points on the screen that are so situated as to be illuminated by an orthogonally incident beam will be rendered as circular dots, while points so situated that they are illuminated by more obtuse beam incidence will be rendered as elliptical dots.

Yet further limitations on creating a self-contained laser projection apparatus of acceptably shallow depth for signage are also related to obtuse beam incidence. To an observer in front of the screen, the perceived brightness of an illuminated point is at a maximum when the projected beam rendering the point is orthogonally incident to the screen. As the incidence of the beam to the screen becomes more obtuse, the perceived brightness of the rendered point diminishes.

### Objects and Advantages

It is an object of the present invention to provide an improved sign apparatus with a display having the intensity and vividness of neon, that is self-contained and suitably proportioned in ratio of depth to display area for a wide range of signage applications.

It is a further object of this invention to provide such an improved sign apparatus whose display may be easily changed.

It is a further object of this invention to provide such an improved sign apparatus permitting animation of its displays.

It is a further object of this invention to provide such an improved sign apparatus permitting presentation of a plurality of images over a relatively short time, enabling a single sign to present several advertisements to a viewer.

It is a further object of this invention to provide such an improved sign apparatus that is adaptable to network control with one-to-few and one-to-one cardinality.

It is a further object of this invention to overcome the limitations of the prior art in rendering points of relatively uniform beam spot circularity and apparent image brightness over an entire display surface.

These and other objects of the invention will be apparent to those skilled in this art from the following detailed description of a preferred embodiment of the invention.

### BRIEF SUMMARY OF THE INVENTION

The present invention is a self-contained, laser illuminated sign presenting intensely lighted and vividly colored displays, that is programmable to display one or more user designed images, allows animation, and is adaptable to network control. The sign is a rear projection display device employing a light source of substantially parallel beams, such as a laser. In some embodiments, low depth to display dimension ratio is obtained by extending the projected light path by internal reflection. Distortion of the projected dot resulting from oblique projection angles is astigmatically corrected, in some embodiments by employing suitably selected reflective or refractive cylindrical or aspheric lenses. In preferred embodiments, the incident oblique projected beam is refracted near orthogonal to the screen by use of a suitably designed and oriented transmissive structure such as a film or plate with a repeating microreplicated prism. To optimize beam normalization, in some preferred embodiments the repeating microreplicated prism in the transmissive film or plate is laid out in a specific pattern and the deviation angle and prism pitch of the microreplicated prism is varied over the screen area to match incident angles of projected light. Pincushion, keystone and anamorphic distortion of an obliquely projected image is corrected, either by software pre-processing of the image data or by hardware and/or software means correcting the deflection angle of the projected light.

### BRIEF DESCRIPTION OF THE DRAWINGS

The foregoing objects, as well as further objects, advantages, features and characteristics of the present invention, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a diagram of a prior art embodiment of a laser projection system.

FIG. 2 is a diagram of a prior art embodiment enabling combination of a plurality of light sources for production of varying projected colored light.

FIG. 3 is a front elevational depiction of the present invention.

FIG. 4 is an illustration of the beam path in an embodiment of the present invention employing two internal reflections to extend the path of the beam.

FIG. 5 is an isometric view of the beam path shown in FIG. 4.

FIG. 6 is sample scan angle and beam distortion calculations for several devices with varying dimensions and internal reflections.

FIG. 7 is a diagram of a top view of an embodiment employing a curved mirror to reflect projected light.

FIG. 8 is a diagram illustrating correction of the projected dot astigmatism resulting from oblique projection as taught by the present invention.

FIG. 9 is a diagram of a rear view of an embodiment employing a plurality of curved surfaces to reflect projected light and correct projected dot astigmatism.

FIG. 10 is a diagram illustrating a light beam incident transmissive right angle film comprising repeating microreplicated prisms.

FIG. 11 is a diagram showing one embodiment of a plurality of sign apparatus operating under network control with one-to-few or one-to-one cardinality.

### DETAILED DESCRIPTION OF THE PREFERRED EMBODIMENTS

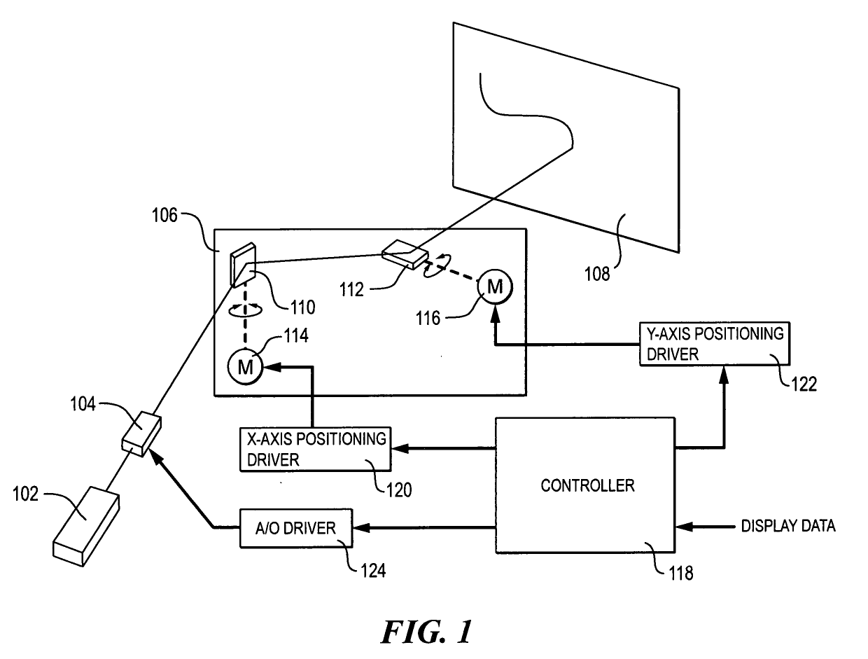

Prior art laser projection devices generally employ galvano-mirrors to control the deflection of projected laser light to produce images. Referring to exemplary prior art illustrated in FIG. 1, a beam emitted from light source 102 of substantially parallel beams, such as a laser, enters a light modulator, e.g. an A/O (acousto-optic) modulator 104. Instead of the A/O modulator 104, an E/O (electro-optical), mechanical, or other modulator may be used. After passing through the A/O modulator 104, the beam is deflected two-dimensionally by a galvanometer scanner 106 provided as a two-dimensional deflection means, and is projected on a screen 108. The galvanometer scanner 106 comprises a pair of beam deflecting galvano-mirrors 110 and 112 for x-axis scanning and y-axis scanning respectively, having two axes perpendicular to each other at the center of oscillation, and of a pair of servo motors 114 and 116 for angle control of mirrors 110 and 112 respectively. By employment of galvanometer scanner 106, the deflected beam projected on the screen 108 moves across the screen surface to render vector graphics. In the alternative, by employment of a rapid x-axis scanner, a slower and suitably timed y-axis scanner, and a suitably bright laser light source, the deflected beam may scan the entire screen in the manner of a raster, rendering raster graphics by illuminating specific screen points as pixels over time.

Programmatic control of the rendered image is accomplished by the processing of programmatic display data over time by controller 118, typically a digital to analog (D/A) converter, providing a sequential signal of x position data to x-axis positioning driver 120 controlling servo-motor 114 directing mirror 110 for x-axis translation, and a sequential signal of y position data to y-axis positioning driver 122 controlling servo-motor 116 directing mirror 112 for y-axis translation. Controller 118 controls the intensity of the beam by directing acousto-optic driver 124 to control acousto-optic modulator 104. At points when the x,y position on the image is to move without illumination, controller 118 sends a control signal to acoustic-optic driver 124 which directs acousto-optic modulator 104 to cut off transmission of the beam entirely.

As will be clear to those of skill in the art, light source 102 of substantially parallel beams may comprise a selection from a variety of laser light sources, such as He—Ne, ion, neodymium doped yttrium aluminum garnet (ND:YAG) or diode, such as supplied by Coherent, Inc. of Santa Clara, Calif. Further, since the intensity of the light emitted by some lasers, such as diode lasers in particular, may be rapidly varied at the source, embodiments employing such light sources may not require an external intensity modulator such as acousto-optic coupler 104. Further, as will be appreciated by those of skill in the art, light source 102 is not limited to lasers alone, but may comprise any of a number of sources of intense, substantially parallel light beams, such as a master-oscillator parametric amplifier (MOPA), super-luminescent diode (SLD) or even an arc lamp. Every description of the present invention in this specification referring to “laser” is to be understood to encompass such other sources of substantially parallel beams as well.

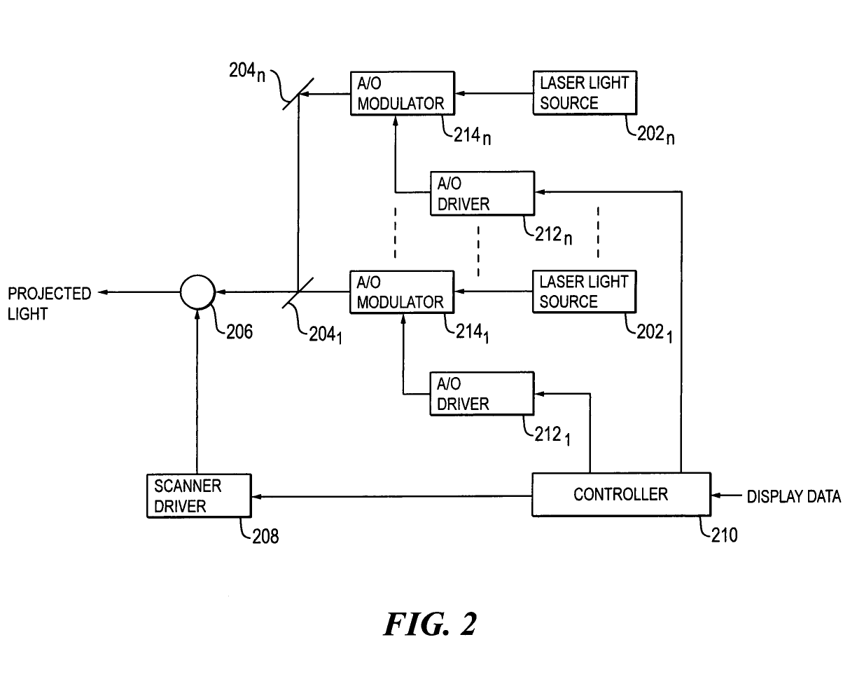

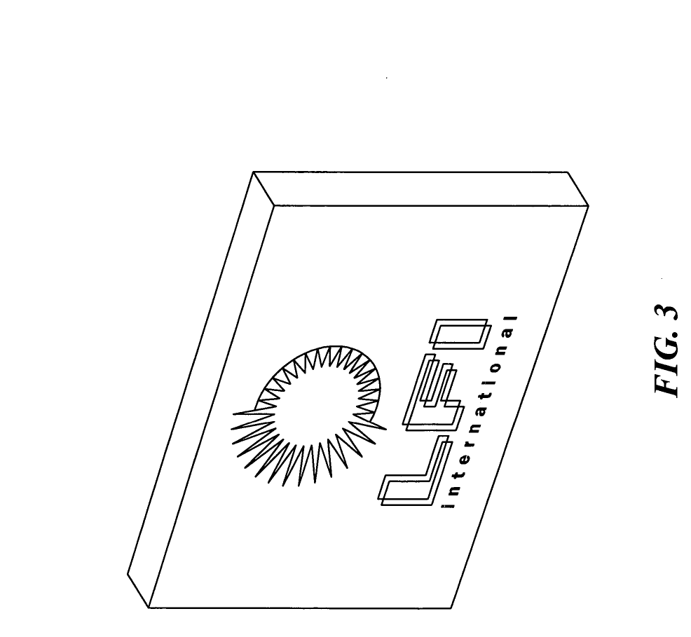

Yet further appreciated by those of skill in the art, the functionality of intensity modulator 104 may be implemented on its own as depicted in FIG. 1, or as part of a color control system described in more detail below in reference to FIG. 2.

Display data generally is computer generated and created employing computer software such as Lasershow Designer from Pangolin Laser Systems of Orlando, Fla. Geometrical correction can accomplished within such software, or may be performed externally, as with the Geo 2.2 geometrical correction circuit from LFI International, Inc. of Bellevue, Wash. Such data is used by controller 118 to control the x,y position of the projected beam as well as to control the color of the beam as described below.

As is known to those in the art, the functionality of controller 118 may be accomplished by the employment of readily available D/A hardware such as the QM2000 PCI bus board from Pangolin Laser Systems of Orlando Fla. Such hardware provides positional information to drivers 120, 122 to drive controllable deflection hardware 110, 114 and 112, 116, such as the 6800HP galvanometer from Cambridge Technology in Cambridge Mass.

For projection surface 108, the present invention, being a self-contained, backlit laser projection system, employs screen material capable of high contrast and resolution under high levels of ambient light, such as Black Bead from DNP Denmark A.S. of Karlslunde, Denmark.

The color of the projected beam may be varied in a number of ways well known to those of skill in the art. For illustrative purposes, turning now to FIG. 2 depicting prior art for varying the color of the projected beam, the color of the beam may be adjusted by providing a plurality of laser light sources 202₁-202ₙ of different wavelength composition, by modulating each laser beam individually through acousto-optic modulators 214₁-214ₙ (or other modulation method) disposed for each light source, by synthesizing the light through dichroic mirrors 204₁-204ₙ, combining and guiding it to the galvanometer scanner 206. Scanner 206 projects the combined light under direction of scanner driver 208 controlled by controller 210, positioning the projected light along x- and y-axes as described above in reference to FIG. 1. As is well known in the art, Red-Green-Blue (RGB) color combination technology may be employed with such a system to produce light of apparent color over much of the visible spectrum. An array of acousto-optic modulators 214₁-214ₙ as depicted for combining sources to vary apparent light color is provided in the Acousto-Optic Modulator model number 3110-121 by Crystal Technology, Inc. of Palo Alto, Calif. Typical control of a laser projection apparatus is by utilizing controller 210 to send RGB/intensity control signals to drivers 212₁-212ₙ controlling acousto-optic modulators 214₁-214ₙ for such an array, varying the intensities of the different wavelengths of light in the array that are combined in the projected light, as the controller sends x-y position signals to drivers for x-axis and y-axis positioning (refer back to FIG. 1).

As is well known to those in the art, another means of projecting light with variable apparent color comprises the use of a polychromatic acousto-optic modulator (PCOAM), such as the Polychromatic Laser Wavelength Modulator System for modulator model number N48062-2.5-.55 of Neos technologies, Inc. of Melbourne, Fla. In PCOAM, an incident polychromatic laser beam (i.e. comprising a mixture of light at various wavelengths) is passed through an electronically tunable optical crystal, such as Tellurium Dioxide. Specific RF frequencies are applied to the crystal, resulting in specific wavelengths being diffracted into the first order. Multiple frequencies will cause multiple spectral lines to be diffracted. The output face of the crystal is cut at a prismatic angle, so that all lines are superimposed to form a single composite output beam. The intensity of each line, i.e. of each frequency comprising light in the output beam, is a function of the RF power at the particular frequency. In this manner, the PCOAM varies the intensities of the different wavelengths of light comprising the output beam and thereby controls the apparent color of the projected light.

Turning now to the present invention, provided is a self-contained rear projection laser display device, with a low depth to display area ratio suitable for signage applications, as illustrated in FIG. 3.

If scanners are available with a very wide deflection angle range, perhaps greater than 120 degrees, then it is possible to embody the present invention with a single scanned light source by projecting the light directly from the scanner located in the back of the device opposite the screen. However, as stated earlier, because the deflection angle capability of present art galvanometric scanners is limited to about 60 degrees or less, if the beam path from the scanner to the screen is short, then the size of the projectable area is small. Accordingly, this invention is directed in part to solving the problem of producing a relatively large screen area with a relatively small device depth.

A possible solution to the problem presented by the limited deflection angle of present art scanners would be to construct the present invention with multiple scanner sources, each one of which covers only a portion of the screen, thereby not requiring large deflection angle capability in any scanner. However, because the scanner assembly is among the more expensive components of the present invention, such a solution entails significant additional cost.

A more cost-effective solution with present laser projection technology is effectively to extend the beam path to be considerably longer than the device depth. Embodiments of the present invention extend the beam path by locating the x-y scan source considerably off-center of the screen and back from the plane of the screen, and employing one or more internal reflections along the longer side of the screen dimension between the x-y scan source and the screen.

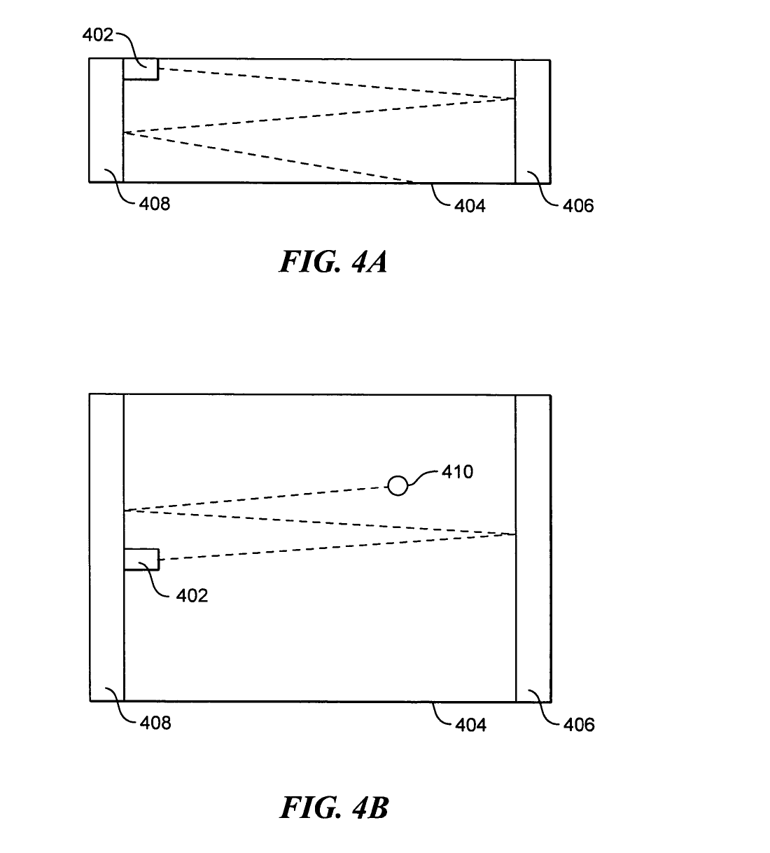

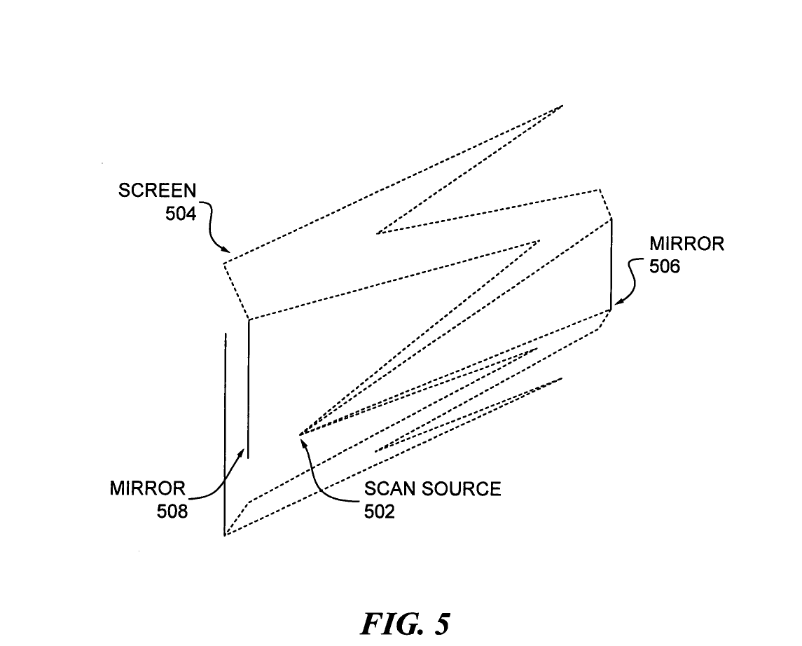

Turning to FIG. 4, illustrated is a top view (FIG. 4a) and a side view (FIG. 4b) of a preferred embodiment wherein the beam path is internally reflected from planar surfaces twice along the longer side of the screen. Light projected from x-y scan source 402 reflects first off reflecting surface 406 toward reflecting surface 408 to project as point 410 (FIG. 4a) on screen 404 (FIG. 4b). FIG. 5 provides a rear isometric view of the same beam path from x-y scan source 502, to mirrored surface 506, to mirrored surface 508, to screen 504. In some such embodiments, the x-y scan source is located well out of the plane of the screen, toward a rear corner of the device.

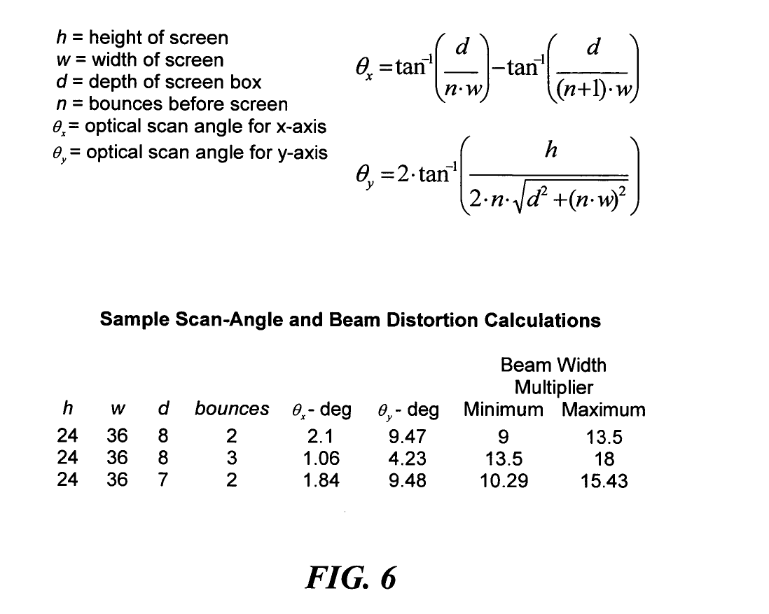

FIG. 6 sets forth scan angle and beam distortion calculations for several exemplary devices with differing dimensions and employing differing numbers of internal reflections from planar reflecting surfaces (“bounces”) according to this embodiment of the present invention. As will be appreciated by one of skill in the art, the requisite x- and y-scan angles are all less than 10 degrees, well within the deflection angle capability of present art galvanometric scanners. Of the three illustrated exemplary devices, the third device, with dimensions of 24*36*7 inches and employing two internal reflections, is preferred in balancing minimized scan angle, total bounces and beam distortion.

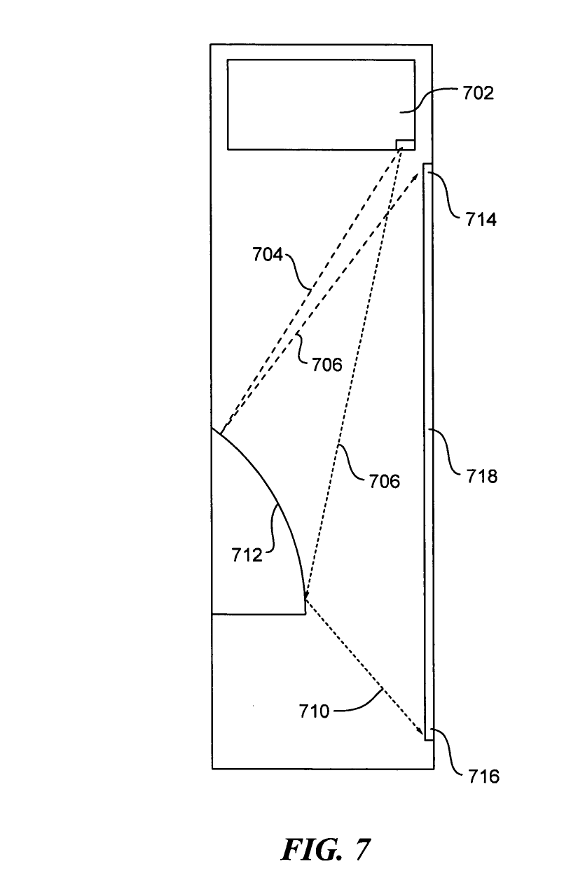

Another solution to the problem of producing a relatively large screen area with a relatively shallow device depth is to employ a mirror of suitably curved geometry for reflecting the beam from the scanner. Turning to FIG. 7, x-y scanning source 702 projects beams 704, 706 onto curved mirror 712, from which are reflected beams 708, 710 projected to points 714, 716 respectively on screen 718. As will be appreciated by those of skill in the art, the geometry of reflection from curved mirror 712 has the effect that a relatively small range of scan angle between projected beams 704 and 706 results in a relatively large range of scan angle between reflected beams 708 and 710. As will be further appreciated by those of skill in the art, source 702 may comprise a scanner from which beams 704, 706 emanate directly, or in the alternative source 702 may be the result of one or more internal reflections from an originating scanner.

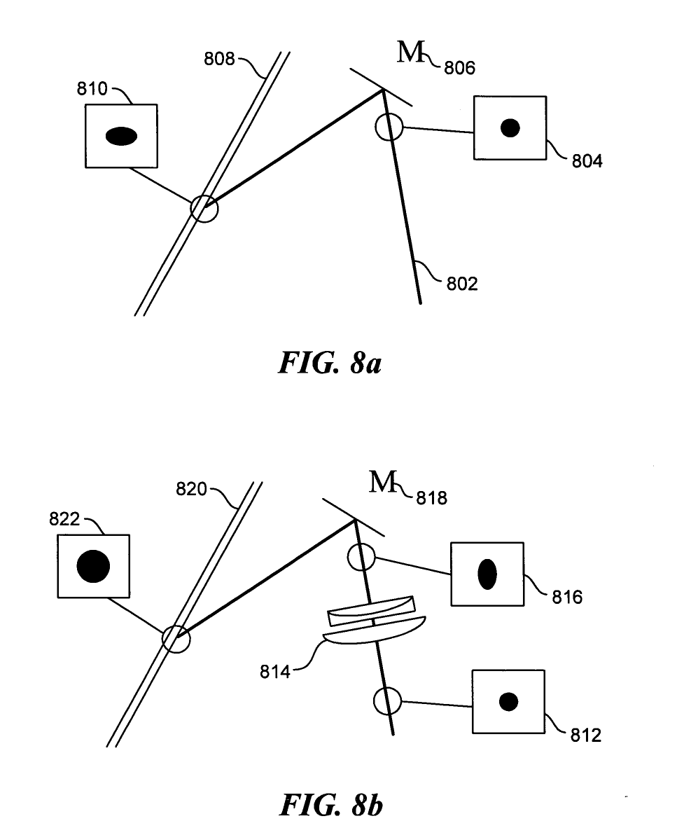

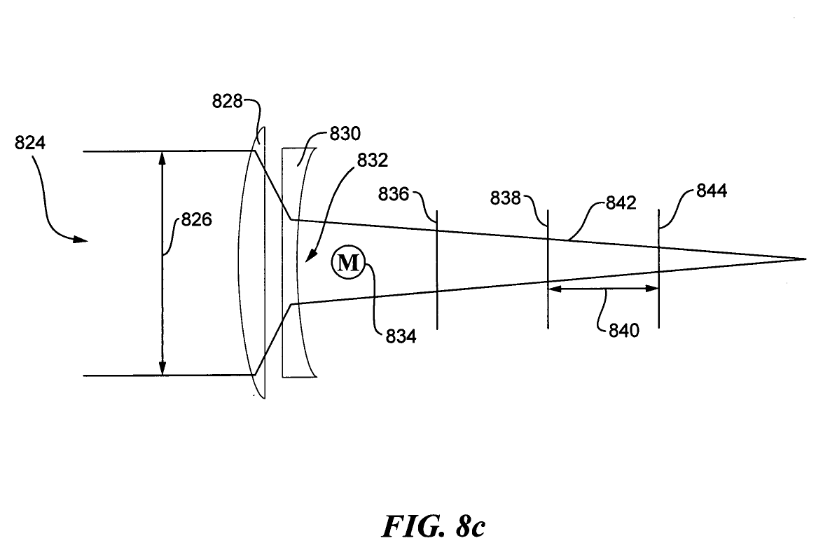

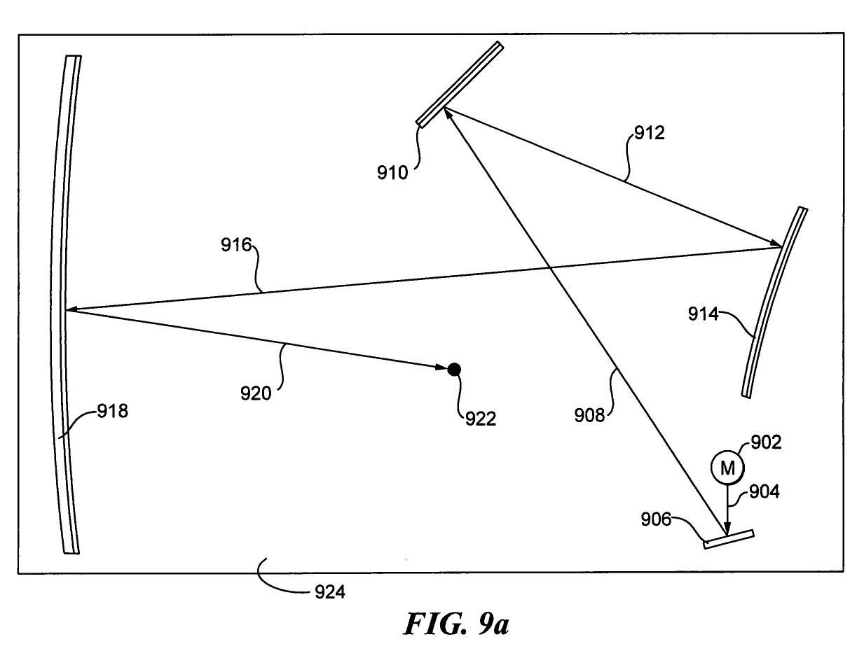

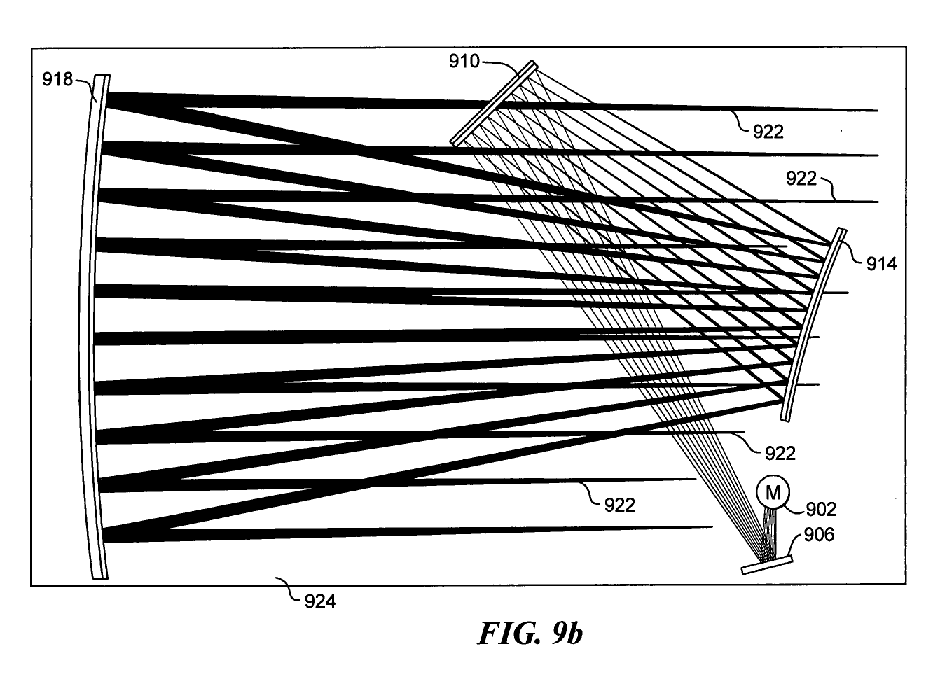

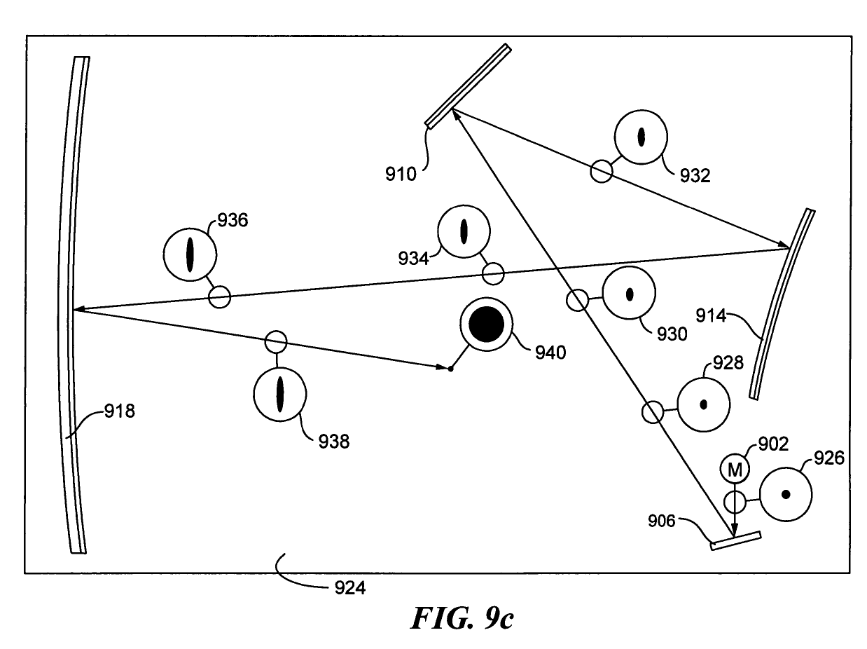

Further along these lines, internal reflection of the beam by employment of one or more mirrors of curved geometry may serve a purpose in addition to increasing the effective scan angle in projecting onto a large screen area from a shallow depth. In shallow depth single source displays, there is another inherent problem, first discussed as follows in respect to FIG. 8, that is advantageously solved by employing curved mirrored surfaces, as will be discussed in greater detail in reference to FIG. 9 below.

Turning first to FIG. 8, however, inherent in the geometry of a shallow depth single source displays is the limitation that, for at least a portion of the display, the angle of incidence of the beam on the screen is highly oblique. Such oblique incidence results in a projected light point that is more or less elliptically shaped with an axis of astigmatic distortion along the vector of the incident beam. As illustrated in FIG. 8a, light beam 802, which has a beam cross section 804 of circular outline, is deflected by scanner mirror 806 to project on screen 808, the projected dot spreading to render an image 810 with elliptical outline.

Embodiments of the present invention correct such astigmatism optically. Illustrated in FIG. 8b is an embodiment of the present invention correcting projection astigmatism by refractive optics placed in the path of the laser beam. The beam with round cross section 812 passes through a suitably selected and oriented cylindrical lens apparatus 814 astigmatically resulting in a beam with elliptical cross section 816, which is then deflected by scanner mirror 818 to project on screen 820, rendering a relatively round disc shaped image 822. In preferred embodiments, astigmatic correcting optics create a beam (which, depending upon embodiment, may be converging, collimated or diverging) such that the resultant beam profile appears rotationally symmetrical when projected at an acute angle to both the near and far sides of the screen area. In the illustrated embodiment, such a beam is created by refracting cylindrical lens apparatus 814 comprising a pair of cylindrical lenses. The focal lengths of such lenses 814, the distance between them, and their distance from scanner 818 and screen 820 vary according to the geometry of the sign apparatus and the locations of light source 802 and scanner 818.

Turning to FIG. 8c, depicting a vertical view detail of an embodiment of astigmatically correcting lens apparatus 814 (FIG. 8b) employing a convergent projected beam, a source beam 824 of width 826 is directed through a first cylindrical lens 828. Lens 828 has a positive focal length to reduce the beam diameter in the axis of astigmatic distortion, as depicted in cross section 816 in FIG. 8b. The corrected beam emerging from lens 828 proceeds through second cylindrical lens 830, which further adjusts the width and convergence of the beam to allow astigmatic correction across the entire projection area. Second lens 830 can have either a positive or a negative focal length. Selection of a specific focal length for second lens 830 will determine the appropriate locations of first lens 828 and second lens 830. Beam 832, convergent in the depicted embodiment, emerges from lens 830 and is deflected as described previously by mirrored scanner 834.

In embodiments employing internal reflection to extend the beam path, such as described previously in reference to FIGS. 4 and 5, beam 832 is reflected by at least one mirrored surface prior to incidence on the screen. FIG. 8c illustrates the unfolded beam path for such an embodiment with two internal reflections utilizing a convergent beam profile. Convergent beam 832 is reflected by a first mirrored surface 836 to a second mirrored surface 838. The beam is projected over the surface area of the screen 840 from a near side 842 to a far side 844. If a converging beam arrangement is used, it may be advantageous to configure the apparatus optics so that the point of convergence of beam 832 is located at a point beyond the screen, assuring a projected beam dot of round dimension. In any case, the precise focal point of beam 832 (if applicable) is chosen based upon the desired dimension of the projected dot.

For embodiments with shorter light beam paths, such as that utilizing a curved reflective mirror as illustrated in FIG. 7, and particularly for embodiments employing a single directly projected, wide deflection angle source, the required amount of astigmatic correction will vary considerably over the surface of the screen, from none for when illuminated location is orthogonal to the source, to a significant amount when the screen location is distal from the source. Furthermore, the orientation of spread will vary over the screen for such embodiments, disposed radially on the screen from a point of orthogonal beam incidence. Selection of optical correction lensing 814 (FIG. 8b) may be made appropriately to provide the necessary astigmatic correction in keeping with the teachings of the present invention.

Depending upon optical requirements, lensing 814 (FIG. 8b) and 828 and 830 (FIG. 8c) may be selected from the Tech Spec™ line of refractive lenses provided by Edmund Industrial Optics of Barrington, N.J.

As will be yet further appreciated by those of skill in the art, while the above discussion is directed to embodiments employing astigmatic correction of the projected beam between the light source and the scanner, other embodiments may be constructed where astigmatic correction occurs instead between the scanner and the screen, for which purpose specialized lensing may be employed for astigmatic correction of the beam between the scanner and the screen. As will be appreciated by those of skill in the art, such lensing may be refractive or it may comprise specialized reflective lensing, with appropriately curved mirrored reflecting surfaces.

Returning to FIG. 8b, as will be appreciated by those of skill in the art, reflective means as well as refractive means 814 may be employed to transform beam 802 with cross section 812 of circular outline to a beam with cross section 810 of elliptical outline, as discussed in greater detail below in reference to FIG. 9.

Turning now to FIG. 9a, a cut-away rear view of a preferred embodiment of the present invention is depicted, wherein curved reflective surfaces disposed between the scanner and the screen are advantageously employed to serve the dual purposes of both increasing the effective scan angle and also astigmatically correcting the eccentricity of the cross-section of the projected beam. Mirrored scanner 902 reflects beam 904 onto curved mirrored surface 906. In the depicted embodiment, surface 906 is a concave cylindrical mirror with axis in the plane of screen 924. Beam 904 is reflected by surface 906 as beam 908, incident on reflecting surface 910. In this embodiment, surface 910 is also a concave cylindrical mirror with axis in the plane of screen 924.

Beam 908 is reflected by mirror 910 as beam 912, incident on reflecting surface 914. Surface 914 is a convex cylindrical mirror with axis orthogonal to the plane of screen 924. Beam 912 is in turn reflected by mirror 914 as beam 916, incident on reflecting surface 918. Mirror 918 is a concave cylindrical reflector, with axis also orthogonal to the plane of screen 924. Beam 916 is reflected by mirror 918 as beam 920, incident on screen 924 as dot 922.

FIG. 9b illustrates the beam path for beams projected along the reflecting path described above. As can readily be seen, this embodiment serves to increase the effective scan angle of the projected beam, as is necessary for shallow depth single source displays. The relatively narrow scan angle of beams emanating from mirrored scanner 902 incident on reflective surface 906 is spread by the reflective optics of surfaces 906, 910, 914 and 918, resulting in widely dispersed collimated beams incident 922 to screen 924.

In the preferred embodiment, curved mirrored surfaces serve not only to permit wide dispersion of beams originating from a relatively narrow scan angle, they also perform astigmatic correction of the eccentricity of the cross-section of the projected beam. Turning to FIG. 9c, mirrored scanner 902 projects a beam of circular cross-section 926 which is reflected by mirrored surface 906, which is has convex cylindrical curvature along an axis approximately coplanar with the reflected light path within the apparatus. The beam reflected by surface 906 is of narrowing elliptical cross-section 928, 930 and is further reflected, in turn, by a second mirrored surface 910, which is also of convex cylindrical curvature along an axis that is similarly approximately coplanar with the reflected light path. The beam reflected by surface 910 is approximately collimated with narrowed cross-section 932. This beam is reflected by mirrored surface 914, which is of convex curvature along an axis that is approximately perpendicular to the plane of the reflected light path, resulting in a beam of further heightened elliptical cross-section 934, 936. Finally, the beam is reflected by mirrored surface 918, which is of concave curvature along an axis approximately perpendicular to the plane of the reflected light path. The beam reflected by surface 918 is obliquely incident screen 924.

The optical result of the reflection of the beam by surface 918 is the collimation of the beam, resulting in a beam of relatively uniform elongated elliptical cross-section 938 along the width of the screen 924. The incidence of this uniformly elongated ellipse at a relatively invariant oblique angle over the surface of screen 924 results in a fairly circular projection 940 of relatively uniform dimension over the entire screen area.

In addition to correction by fixed optics as described above in reference to FIG. 8 and FIG. 9, the eccentricity and orientation of the cross section of the projected beam may be varied appropriately by electromechanical means dynamically adjusting appropriately fashioned optical correction apparatus. Referring to FIG. 8b, such adjustable eccentricity may be achieved by adjusting the orientation of lens 814 with respect to light beam 802 as necessary to achieve the astigmatic correction required for a given location for image 822 on screen 820. As will be appreciated by those of skill in the art, suitable electromechanical technology, such as a galvanometric translation device coupled to lens 814, together with a screen-location dependent driver, may be employed to provide a precise astigmatic correction for any given screen location. As will be further appreciated by those of skill in the art, other optical and mechanical means may be employed to vary the eccentricity and orientation of beam correction to match the requirement for a relatively circular projected dot at any given screen location.

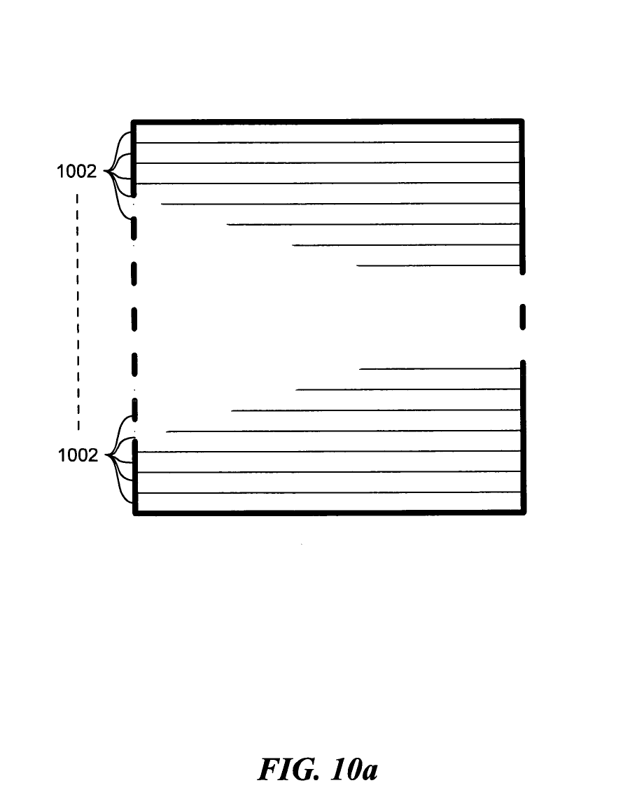

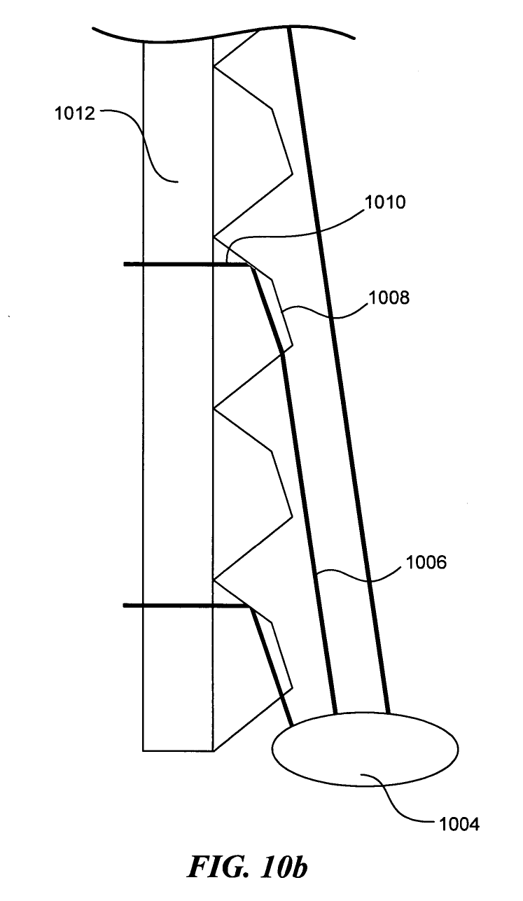

Yet another limitation resulting from the oblique incident angle of the projected beam in the various embodiments is the fact that, as the angle of light emitted from the screen varies from orthogonal, the perceived brightness of an illuminated spot is diminished for a viewer in front of the display. Accordingly, preferred embodiments of the present invention employ a structure to refract the obliquely incident beams prior to their transmission through the screen material to enhance the brightness of the projected spot. A structure suitable for such purposes is transmissive right angle film, such as Vikuiti™ from Minnesota Mining and Manufacturing Corporation of St. Paul, Minn., and variations thereof. As illustrated in FIG. 10a, such light transmissive film comprises a repeating microreplicated pattern of prismatic lines 1002. A modified microreplicated prism is shown in cross-section in FIG. 10b, where a light source 1004 emits obliquely incident light beam 1006 which is refracted by microprism 1008 to exit as beam 1010 roughly orthogonal to screen material 1012. In Vikuiti™, the film thickness is 155 μm, the prism pitch is 50 μm and the microprism deviation angle is 71°, this latter enabling the normalization of light incident at an angle of 0° to 20°. The microprismatic film illustrated in FIG. 10b is modified whereby the top portion of each prism is removed so that oblique light destined for incidence on points distal the light source can clear the top of prisms proximate the light source.

While the linearly arranged series of uniform microprisms illustrated in FIG. 10a may be sufficient to normalize the beams for embodiments with relatively uniform oblique beam incidence over the screen surface (as in the internally reflecting embodiment described above in reference to FIGS. 3 and 4), when the angle of beam incidence varies widely over the screen a different arrangement of microprisms may be required to normalize the angle of the emitted beam, because linearly arranged microprisms may not be optimal for normalizing beams when the axis of distortion varies widely. In the embodiment employing a beam directly projected from a scanner to the screen, as described previously, when the illuminated location is orthogonal to the scanning source, the beam is orthogonally incident to the screen, while, proceeding radially from such a point, the beam incidence becomes progressively more oblique. More complex geometries apply to some embodiments employing a curved mirror as described above in reference to FIG. 7. As will be appreciated by those of skill in the art, transmissive right angle structures adapted for normalization of emitted beams in such embodiments with wide ranging beam incidence must vary the deviation angle of the microprism appropriate to the angle of beam incidence over the surface of the display area. Optimally, the microprisms should be arranged so that they are orthogonal to the axis of light incidence at each location on the screen. An advantage of the embodiment described in reference to FIG. 9, referring specifically to FIG. 9b, is that, because the beams projected toward the screen are collimated by the apparatus optics, they have substantially the same axis of distortion over the entire surface of the screen, whereby linearly arranged microprisms such as illustrated in FIG. 10a will serve to normalize incident beams sufficiently for acceptably uniform point brightness over the entire surface of the screen.

Returning to FIG. 1, it will be appreciated by persons of skill in the art that the geometries of various embodiments of the present invention may each require specific correction of such display data provided to controller 118 to render an image with minimized distortion. Beginning with data appropriate for a laser projection system with long beam path and screen orthogonal to the beam path, considering the internally reflected embodiment described with reference to FIGS. 3 and 4, for example, keystone correction of such data will be necessary in general for the embodiment to render images with minimized distortion. As will be appreciated by persons of skill in the art, other forms of correction, including pincushion and anamorphic correction, may be required for display data for other embodiments. Such correction may be accomplished by software processing of the display data before it is provided to the present invention, or in the alternative such correction may be accomplished by software and/or hardware providing correction on-the-fly within the apparatus. Hardware suitable for such correction is Geo 2.2 from LFI International, Inc. of Bellevue, Wash., as mentioned previously above.

The described geometric correction systems provide corrected x axis and y axis outputs as an algebraic function of uncorrected x axis and y axis inputs, and are appropriate for vector-based displays. For example, the x axis output of a simple, exemplary geometric correction system may be algebraically defined as x′=(xscale+xkey*y)*x where x and y are the source signals, xscale and xkey are constants of correction, and x′ is the resultant corrected x-axis signal. The algebraic functions can be generalized as x′=fx(x,y) and y′=fy(x,y)—that is to say that the x-axis and the y-axis outputs are each a function of both the x and the y axis inputs.

Embodiments of the present invention directed to raster based display technology may, in addition, advantageously correct a displayed image by adjusting timing of the intensity/RGB signal for X-axis corrections and modifying the Y-axis signal as necessary.

For x-axis corrections, timing is adjusted to provide spatially consistent pixel organization despite variations in projection angles and geometries, and of x-axis scanner movement rates which occur as a result of scanner inertia and limitations on scanner frequency response. For example, as the scanner's velocity of angular rotation decreases in preparation for a change of direction, the “pixel clock” driving the intensity/RGB signal must likewise decrease in frequency to provide spatially even pixels despite a velocity change in the scanner. Similarly, astigmatic or “linearity” correction can be achieved by increasing the “pixel clock” rate for areas which appear to be horizontally stretched when uncorrected, and by decreasing the rate for areas which appear to be horizontally compressed. The clock rate is adjusted to provide x′=f(x,t) where x′ is the current horizontal position as referenced to the clocked pixels, x is the actual horizontal position of the beam positioned by the scanner, and t indicates elapsing time. For y-axis corrections, the incoming y-axis signal is adjusted according to the pixel-clock-determined x position, x′; this can be defined algebraically as y′=f(x′,y).

It can be seen that the invention described herein provides an improved sign apparatus with a display having the intensity and vividness of neon, that is self-contained and suitably proportioned in ratio of depth to display area for a wide range of signage applications. Referring back to FIG. 1, the display presented by the sign is based upon programmatic display data that is presented to controller 118. From a given set of display data, the rendered display is not limited to a static image, but rather may entail the presentation of multiple images or animation, some advantages of which are set forth above.

Furthermore, because the image or images presented by the sign are determined by display data that is programmable, the present invention enables a wide range of business methods for such signage. The present invention permits quick and economical programming of individual signs by a number of input methods. For example, an individual sign may allow creation of display data on-site, such as by an integral input device or a personal computer or laptop serial interface. Embodiments may provide for on-site input of display data from a portable storage medium, such as diskette, smart card, portable USB storage and the like. Particularly advantageously, embodiments may provide for remote or networked control, for example by Internet Protocol addressing, through a wired medium such copper or fiber-optic connectivity, or through wireless connectivity such as EEE 802.11b and 802.11g.

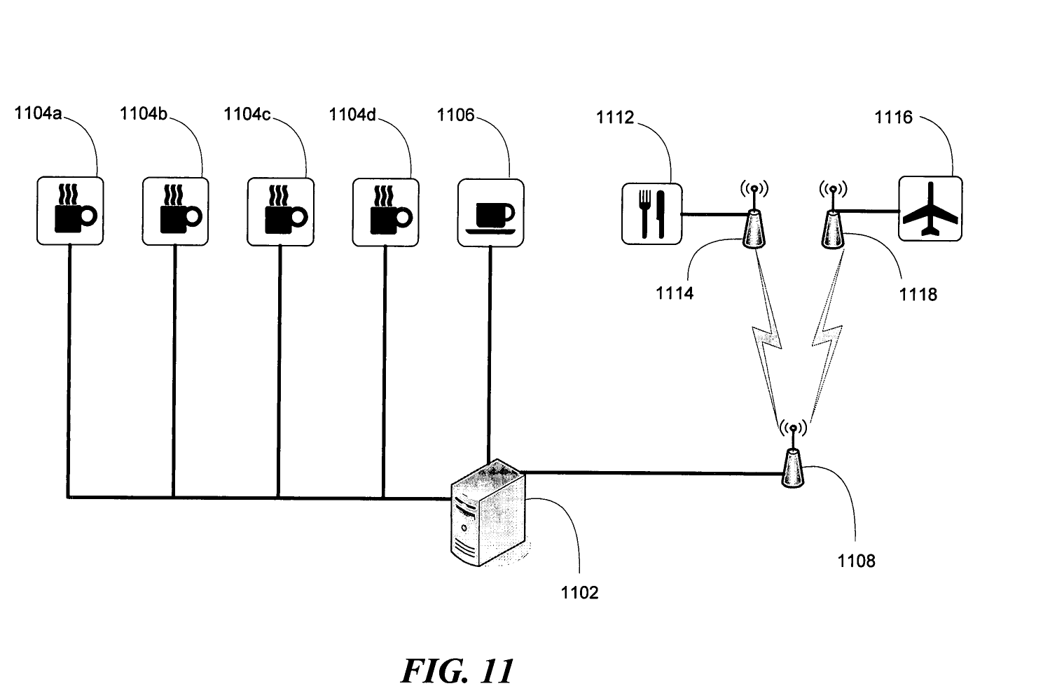

Referring now to FIG. 11, depicted is a network of a plurality of signs. Under broadcast control of server computer 1102, signs 1104a-1104d are programmed to display identical content. Sign 1106 is individually addressed by server computer 1102 to display unique content. Server 1102 is connected to wireless access point 1108 to broadcast wireless control data to signs 1112, 1116 via wireless network connections 1110 and 1114 respectively. As will be clear to those of skill, the present invention permits networked communication and control of signs by these as well as the plethora of other protocols and technologies known in the networking arts.

Such embodiments permit not only broadcast reprogramming of large groups of signs in concert with commercial and business needs, but also narrowcast one-to-one and one-to-few timely signage, with the obvious advantage of delivering advertising tailored to current business and market requirements as well as to the demographics applicable to different sign locations.

While much of the foregoing specification has been directed to applications of the present invention for signage, it will be clear to those of skill in the art that the improvements taught herein and the apparatus enabled thereby may also advantageously be used for raster based television technology. Specifically, the present invention permits a back lit laser television set apparatus with an intense and vivid display, with optimally minimized image distortion, that is self-contained and therefore radiologically preferred, and is suitably proportioned in ratio of depth to display area for use in the home.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A self-contained, illuminated display apparatus, comprising
an internal light source projecting a beam;
a means for receiving the beam and controllably deflecting the beam in a given direction to produce a deflected beam;
a translucent screen for receiving the deflected beam at an incident angle, the screen transmissively displaying a back-lighted dot; and
a means, disposed between the internal light source and the means for receiving and deflecting the beam, for correcting astigmatic distortion of the displayed back-lighted dot when the incident angle of the deflected beam on the screen is oblique.

26. A display apparatus according to claim 25, wherein
the means for correcting astigmatic distortion is selected from the group consisting of refractive optical correction and reflective optical correction of the beam.

27. A display apparatus according to claim 25, wherein
the means for correcting astigmatic distortion is a cylindrical lens apparatus causing the beam to become a converging beam.

28. A display apparatus according to claim 25, further comprising
a programmatically controlled means of correcting distortion of projected images.

29. A display apparatus according to claim 28, wherein
the display scans images in a vector format; and
the means for correcting geometric distortion of projected images provides corrected x and y axis outputs which are an algebraic function of the uncorrected x and y axis inputs.

30. A display apparatus according to claim 28, wherein
the display scans images in a raster format; and
the means for correcting distortion of projected images provides corrected y axis and pixel timing outputs which are a function of the uncorrected x and y axis inputs and elapsed time.

31. A self-contained, illuminated display apparatus, comprising:
an internal light source projecting a beam with a light path;
a means disposed in the light path for receiving the beam and controllably deflecting the beam in a given direction to produce a deflected beam;
a translucent screen disposed in the light path for receiving the deflected beam at an incident angle, the screen transmissively displaying a back-lighted dot; and
a means, disposed in the light path between the internal light source and the means for receiving and controllably deflecting, for correcting astigmatic distortion of the backlighted dot when the incident angle of the deflected beam on the screen is oblique.

32. A display apparatus according to claim 31, further comprising
a programmatically controlled means of correcting distortion of projected images.

33. A self-contained, laser illuminated display apparatus with depth orthogonal to a display surface of width and height, wherein the depth of the apparatus is less than at least one of the display width and the display height, and comprising:
an internal laser light source projecting a beam with a light path;
a means disposed in the light path for receiving the beam and controllably deflecting the beam in a given direction to produce a deflected beam;
a translucent screen disposed in the light path for receiving the deflected beam, transmissively displaying a back-lighted dot;
a means for collimating the beams in the light path prior to the screen;
a means, disposed in the light path between the internal light source and the means for receiving and controllably deflecting, for correcting astigmatic distortion of the backlighted dot when the incident angle of the deflected beam on the screen is oblique;
a means for normalizing the light path when the beam is obliquely incident to the surface of the screen, whereby the normalized light path is roughly orthogonal to the surface of the screen; and
a means for programmatically correcting distortion of projected images.
